(19) United States
(12) Patent Application Publication
(10) Pub. No.: US 2016/0328433 A1
(43) Pub. Date: Nov. 10, 2016

(54) Representing Large Body of Data Relationships

(71) Applicant: DataESP Private Ltd., #02-18 (SG)

(72) Inventors: Yang WANG, Waterloo (CA); Tan WANG, Toronto (CA)

(73) Assignee: DataESP Private Ltd., #02-18 (SG)

(21) Appl. No.: 14/856,175

(22) Filed: Sep. 16, 2015

(30) Foreign Application Priority Data
May 7, 2015 (SG) 10201503587X

(51) Int. Cl. G06F 17/30; G06N 7/00

(52) U.S. Cl. CPC G06F 17/30345; G06N 7/005

(57) ABSTRACT

Representing a large amount of association patterns in the form of data events in a computer system is accomplished by use of a unified framework based on attributed hypergraph (AHG). Data relationships are stored as attributed hypergraphs in a computer or computer network, ready for querying and further analysis. This invention is simple yet general enough to directly encode association patterns of different orders discovered from large databases or raw data relations with arbitrary properties. Both qualitative relations (if A and B are related) and quantitative relations (A and B are related k % of the time) are represented as attributed hyperedges. Such representation is lucid and transparent for visualization. It supports ad hoc and complex associative queries while requiring no physical pre-design or restructure. Thus, a computer storage and retrieving system (e.g., a database) can be readily implemented to store and manipulate huge amounts of relations in accordance with an AHG representation. This is particularly important and useful for statistical patterns from machine and/or human generated data source, including but not limited to social media, manufacturing, and scientific research.

### TECHNICAL FIELD

The present disclosure relates to a method of representing a large body of data relationships, and more particularly, to a method of representing a large amount of data relationships among data events using an attributed hypergraph (AHG), such that the large amount of data relationships can be stored and retrieved in an efficient way for analysis.

### BACKGROUND

For most applications of AI, including machine learning, knowledge discovery from databases (KDD) and Big Data analysis, the choice of knowledge representation is a difficult task. A paper by W. A. Woods entitled “What's important about knowledge representation,” Computer, 16(10), October 1983 (hereinafter “Woods”) suggests that two measurements, expressive adequacy and notational efficiency, should be used to evaluate the performance of a knowledge representation, and in general the paradigm of pattern

storage, retrieval and manipulation.

In data mining, or knowledge discovery in databases, particularly in the era of Big Data, large quantities of patterns in the form of relationships of data events need to be properly represented in a form suitable for achieving the KDD system user's goal. Since the goals relating to such a system are often vaguely defined and change with time, data and data relationship representation tends to be more important for a KDD system than a conventional transaction processing system. In addition to the requirements proposed by Woods, several other aspects should be considered. First, the representation scheme should offer a mechanism for easy knowledge re-organization or focus on a certain portion of the knowledge to meet changing goals. Second, the representation scheme needs to be scalable and support fast querying and retrieval from a large body of relations. Since data in the real world usually contains noise and uncertainty, patterns extracted by a KDD system are generally probabilistic. It is required that numerical inferences be supported by the representation in addition to logical inference. Finally, since the patterns detected from large databases could be of different orders, and since high order patterns cannot be induced by lower order relations, different order patterns should be explicitly represented. Further information is provided in a paper by A. K. C. Wong and Y. Wang, entitled “Discovery of high order patterns,” Proc. Of The 1995 IEEE Int'l Conf. On SMC, volume 2, pages 1142-1148, Vancouver, BC, Canada, 1995”.

Over the years, numerous representation schemes for data relationships have been reported. The most popular one is the relational model of data proposed in a paper by E. F. Codd, entitled “A relational model of data for large shared data banks,” Communications of the ACM, 13(6):377-387, 1970, which forms the basis of relational database implementations. While efficient and widely adopted for transaction processing, the relational model is known as inefficient for data analysis. Further details in this regard are provided in a paper by J. V. Homan and P. J. Kovacs entitled “A comparison of the relational database model and the associative database model,” Issues in Information Systems, X(1):208-213, 2009; and an excerpt from a book by D. Kroenke, entitled Database Processing: Fundamentals, and Implementation,” Prentice Hall, 7th edition, 2000 (hereinafter “Kroenke”).

A relational data model requires physical design ahead of time, and relies heavily on knowledge of the problem domain for operation (e.g. indexing and key constraints).

Other than the relational data model, there are other concepts to represent data and data relationships, especially to support data analysis (instead of transaction processing), such as a hierarchical model described in a paper by D. C. Tsichritzis and F. H. Lochovsky, entitled “Hierarchical data-base management: A survey,” ACM Computing Surveys, 8(1):105-123, March 1976; a network/graph model described in a paper by R. Angles and C. Gutierrez, entitled “Survey of graph database models”, ACM Computing Surveys, 40(1):1:1-1:39, February 2008 (hereinafter “Angles”); and specifically for knowledge management, rule models and logic models.

A hierarchical data model organizes data into a tree-like structure. The data is stored as records which are connected to one another through links. It mandates that each child record has only one parent, while each parent record can have one or more child records. In order to retrieve data, the whole tree needs to be traversed. By its nature, a tree directly represents only the first order relationships as parent-child links.

Trees can be considered as a special case of graphs. Graph representations, such as Bayesian and Markov networks, and the data model derived from directed graphs (see Angles), usually provide more general methods to represent patterns. They directly represent the first order associations between two nodes by links. However, as observed in a text by Pearl, entitled Probabilistic Reasoning in Intelligent Systems: Networks of Plausible Inference, Morgan Kaufmann, 1988 (hereinafter “Pearl”), graph-based representations, including trees and networks, cannot distinguish between set connectivity and connectivity among their elements. Hence, they are not general enough for representing different order patterns.

Production (if-then) rule is another scheme widely used in expert systems and classification oriented tasks. It explicitly presents the association between a set of observations (left-hand antecedent) and one attribute value (right-hand consequent). Rules are considered easier to understand than trees. However, in KDD applications, with each changing interest, the values of different attributes have to be predicted. Besides, a huge number of rules have to be obtained. This is sometimes impractical in the real world. See a paper by A. K. C. Wong and Y. Wang, entitled “High order pattern discovery from discrete-valued data,” IEEE Trans. On Knowledge and Data Engineering, 9(6):877-893, 1997. In this case, we need a scheme which can easily re-organize the represented knowledge for different goals of the system.

In addition to attribute (proposition) based representations, relational representations such as Horn clause (see Kroenke for an overview) and First Order Logic are used in learning systems. An overview is provided by S. Muggleton, in “Inductive Logic Programming,” Academic Press, 1992. They are very powerful and expressive formalisms. Since they were originally designed to formalize mathematical reasoning and were later used in logic programming, patterns in them are deterministic rather than probabilistic. To do probabilistic reasoning, special adoptions have to be done. This problem also exists in the structured representations such as semantic networks. Additionally, logic based representations are considered less comprehensible and harder to visualize than graph based representations.

### SUMMARY

An object of embodiments of the present disclosure is to represent qualitative and quantitative data relationships in a framework for data storage, manipulation, and retrieval in support of analysis and modeling involving large or very large amounts of data.

Further objects of the present disclosure include the provision of:
1. a new data/knowledge representation scheme of data relations;
2. a knowledge and data relationship representation language which can encode both the qualitative and the quantitative patterns and is easy to be accessed for analysis and modeling; and
3. elimination of shortcomings of existing database models that are less generic in representing complex relationships, too much data redundancy and inefficient for analysis and modeling.

Other objects and further scope of applicability of embodiments of the present disclosure will become apparent from the detailed description hereinafter; it should be understood, however, that the detailed description, while indicating representative or preferred embodiments of the invention, is for purpose of illustration only, since various changes and modifications within the scope of the invention will become apparent to those skilled in the art from this detailed description.

To achieve the aforementioned objects, the following schemes are provided as part of a new data relationship representation model:

1. Attributed hypergraph (AHG) based representation language, which is general enough to encode information at many levels of abstraction, yet simple enough to quantify the information content of its organized structure
2. Operations on attributed hypergraph data model for manipulating data relationships, including construct, update, retrieval, deletion and other domain specific functions
3. The basis to design and implement a data management system to store data relationships for in-depth analysis and modeling

The present invention, with its generality, versatility, efficiency and flexibility, is well suited for storing and retrieving large quantity of data relationship artifacts. The invention supports data analysis and modeling naturally. Applications are evident in data and knowledge management, data mining, statistical modeling, machine learning, and other fields where data analysis is required.

According to a first aspect of the present disclosure, a method of representing large body of data using data relationships is provided. The method comprises steps of: providing a data set having a plurality of data events, a plurality of data relationships between the plurality of data events, and properties of the data events and the data relationships, the data set being generated from a data source such that all the data events in the data source are collected regardless of whether there exist statistical patterns in the plurality of hyperedges; representing the plurality of data events as vertices; representing the plurality of data relationships as hyperedges; and representing the properties of the data events and data relationships as attributes associated with the vertices or hyperedges, respectively.

According to a second aspect of the present disclosure, a computer readable medium containing program code for representing large body of data using data relationships is provided. The program code executes the steps of: providing a data set having a plurality of data events, a plurality of data relationships between the plurality of data events, and properties of the data events and the data relationships, the data set being generated from a data source such that all the data events in the data source are collected regardless of whether there exist statistical patterns in the plurality of hyperedges; representing the plurality of data events as vertices; representing the plurality of data relationships as hyperedges; and representing the properties of the data events and data relationships as attributes associated with the vertices or hyperedges, respectively.

According to a third aspect of the present disclosure, a method of manipulating large body of data using data relationships is provided. The method comprises steps of: providing a data set containing a plurality of data event and data relationships between the two or more data events in which the data events are represented as vertices, the data relationships are represented as hyperedges, and properties of the data events and the data relationships are represented as attributes of the vertices and the hyperedges respectively, the data set being generated from a data source such that all the data events in the data source are collected regardless of whether there exists any statistical patterns in the data set; and updating the data set as at least one of the data events, the data relationships and the properties are changed.

According to a fourth aspect of the present disclosure, a method of retrieving large body of data using data relationships is provided. The method comprises steps of: providing a data set containing a plurality of data event and data relationships between the plurality of data events in which the data events are represented as vertices, the data relationships are represented as hyperedges, and properties of the data events and the data relationships are represented as attributes of the vertices and the hyperedges, respectively, the data set being generated from a data source such that all the data events in the data source are collected regardless of whether there exists any statistical patterns in the data set; receiving criteria; retrieving vertices and/or hyperedges associated with the criteria; and outputting search results.

Features and advantages of the invention will become more readily apparent from the following detailed description when taken in conjunction with the accompanying drawings.

### BRIEF DESCRIPTION OF THE DRAWINGS

FIG. 1 is a flow chart illustrating a method of representing a data set in accordance with an embodiment of the present disclosure.

FIG. 2 shows an exemplary hypergraph with 8 vertices and 5 hyperedges in accordance with an embodiment of the present disclosure.

FIG. 3 shows the data set representation that has patterns in the XOR relationship in accordance with an embodiment of the present disclosure.

### DETAILED DESCRIPTION

In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated.

In accordance with an embodiment of the present disclosure, the attributed hypergraph is proposed to represent data relationships for the following reasons.

First, because patterns that induce more than two events are a major concern, a framework which is capable of representing the relationships among multiple events has to be used. Second, in probability inference and many other AI techniques, network representations are extensively used. Networks are graphs which can be considered a special case of a hypergraph. Networks explicitly show the relationships between two nodes. However, it is very difficult for networks to represent the relationship among 3 events, any two of which are not related. To illustrate the problem, one can consider an experiment described in the paper by Pearl, with two coins and a bell that rings whenever the outcomes of the two coins are the same. If one ignores the bell, the coin outcomes, say C1 and C2, are mutually independent, but if the bell (B) is noticed, then learning the outcome of one coin should change the opinion about the other coin, which means C1 and C2 are no longer independent. How then can one represent, using a graph (or networks), the simple dependencies between the coins and the bell, or between any two causes leading to a common consequence? If the naive approach is taken and links are assigned to (B,C1) and (B,C2), leaving C1 and C2 unlinked, the graph C1-B-C2 is obtained. This graph suggests C1 and C2 are independent given B. If a link is added between C1 and C2, the graph turns into a complete graph which no longer reflects the obvious fact that the two coins are genuinely independent.

In practice, these kinds of dependencies exist everywhere. Over the years, directed acyclic graphs have been introduced to represent such dependencies. Although the directed acyclic graph representation is more flexible than the undirected graph representation, and it captures a larger set of probabilistic independence, there are still some important shortcomings. First, not all the dependencies that are representable by the undirected graph can be represented by the directed acyclic graph. Second, computational and representational complexities would arise compared to undirected graph representations. Third, the directed acyclic graph cannot represent the type of dependencies induced by probabilistic models in the paper by Pearl. Pearl concludes:
“ . . . no graphical representation can distinguish connectivity between set from connectivity among their elements. In other words, in both directed and undirected graphs, separation between two sets of vertices is defined in terms of pairwise separation between their corresponding individual elements. In probability theory, on the other hand, independence of elements does not imply independence of sets . . . ”

In the attributed hypergraph representation according to the present disclosure, however, higher order relations are not induced by lower order relations. This representation does not depend on pairwise links. The hyperedges are sets that show the associations among their elements which can also be sets. Yet, the basic element of the proposed hypergraph representation is not a variable but a primary event or data event. That is, dependencies occur among events and not variables. In the bell-coin experiment, if the bell can make 3 kinds of sounds, only the first kind of sound, for instance, beep twice, indicates whether or not the outcomes of the two coins are the same. Other signals have nothing to do with the coins (e.g., perhaps they indicate situations of other events.) It is the event [B=beep twice], not B, that relates the outcomes of the coins. In hypergraph representation, the hyperedges of [B=beep twice; C1=head; C2=head] and [B=beep twice; C1=tail; C2=tail] show the relationships among them.

Different sizes of the hyperedges reflect different levels of generalization. The larger the number of vertices in a hyperedge, the more details a concept (pattern) contains. The hyperedges of smaller sizes often represent more generalized concepts (or patterns). One advantage of the hypergraph representation is that it allows easy movement among different levels of generality, which cannot be done (or only with great difficulty) by graph or network representations.

The procedure of constructing an attributed hypergraph is totally “transparent” to the world.

Unlike relational (or column based) databases, AHG based systems do not require extensive physical design before the repository is populated with data. Links and indexes are created on the fly, and no normalization is necessary. Ad hoc queries are supported naturally. The AHG representation is conceptually efficient. Just as with other graphical representations, a variety of mature algorithms can be directly applied to achieve goals such as searching, matching and transforming. The AHG representation is also computationally efficient.

In an embodiment according to the present disclosure, data relationships may be stored as attributed hypergraphs in a computer or computer network, ready for querying and further analysis. Such a representation is simple yet general enough to directly encode association patterns of different orders discovered from data source, large databases or raw data relations with arbitrary properties. Both the qualitative (if A and B are related) and quantitative relations (A and B are related 95% of the time) are represented as attributed hyperedges. Such representation is not only lucid and transparent for visualization, but also can be used for manipulating and retrieving.

The representation method according to an embodiment of the present disclosure supports ad hoc and complex associative queries while requiring no physical pre-design or restructuring. Thus, a computer storage and retrieving system (e.g., a database) can be easily implemented to store and manipulate huge amount of relations in AHG form. This is particularly important and useful for statistical patterns from machine and human generated data sources including but not limited to social media, manufacturing, and scientific research.

In accordance with an embodiment of the present disclosure, a data set that contains a large amount of data in the form of data events in a computer system may be represented using data relationships as described below.

Consider a data set or data domain from which a finite number of observations are made. In accordance with the present disclosure, the observations may collectively compose a finite set of variables and their values, D=xᵢ|1≦i≦M, where M is a finite integer. A component of D is any possible value in the data set with meaning. For example, Adult=True can be a component, as can Age in a range of (25, 50) or Salary=$60,000 if they belongs to the same data set. Adult, Age and Salary are variables, and the variables have their values True, (25, 50) and $60,000.

A data event, atomic event, or event for short, is defined as a component of the data set. Thus, any values in the data set, such as Adult=True and Age ε(25, 50) can be a data event of the data set. The relationships between two data events, such as X₁<X₂, X₁≠X₂ and X₁/X₂=2.5 also may be data events if they are meaningful.

A compound event, or composite for short, is a set of data events and/or another compound events. The order of a compound event is its cardinality. Any first order compound event is a data event. Thus, [Adult=True, Age ε(25; 50)] is a second order compound event. A sub-composite of a composite is a subset of the composite.

Any data event or component event can have properties or attributes such as their probabilities of occurrence in the data domain, or more complex qualifications. For example, in mining statistically significant associations, if a compound event c passes a significant test T, c becomes a significant pattern. The elements of c are said to have a statistically significant association according to the test T or simply they are associated. In this case, the compound event might be connected to T with confidence levels and other statistical qualifications. This can be a property or attribute of the compound event.

For purpose of illustration and aiding understanding, a few basic concepts are defined as below.

“Hypergraph” is defined as a graph representing data structure. Let Y={y₁, y₂, . . . yₙ} be a finite set (n<∞). A hypergraph on Y is a representation of a family H=(E₁, E₂, . . . , Eₘ) (m<∞) of subsets of Y such that 1. Eᵢ≠φ(i=1, 2, . . . ,m), and

$${{⋃}^{m}}_{i = 1} {E}_{i} = Y$$

A hypergraph is made up of vertices, hyperedges and their attributes. The elements y₁, y₂, . . . , yₙ of Y are called vertices, and the sets E₁, E₂, . . . , Eₘ (subsets of Y) are the edges of the hypergraph, or simply, hyperedges.

A “simple hypergraph” is defined as a hypergraph H with hyperedges (E₁, E₂, . . . ,Eₘ) such that Eᵢ=Eⱼ=>i=j. Unless otherwise indicated, hypergraph here in this specification is referred to as simple hypergraph.

The “order of a hypergraph H”, denoted by n(H), is the number of vertices of the hypergraph. The number of edges will be denoted by m(H). Further, the rank of H is the maximum number of vertices in a hyperedge and r(H)=ⱼ^{max|E}^{ⱼ}^{|} and the anti-rank is the minimum number of vertices in a hyperedge and

$$s ( H ) = {min}_{j} \vert {E}_{j} \vert .$$

For a set J⊂{1,2, . . . ,m}, the family

H′=(Eⱼ|jεJ)

is defined as a “partial hypergraph” generated by the set J. The set of vertices of H′ is a non-empty subset of Y.

For a set A⊂Y, the family

H_{A}=(Eⱼ∩A|1≦j≦m,Eⱼ∩A≠φ)

is defined as a “sub-hypergraph” induced by the set A.

An “attribute” of a hypergraph is a data structure associated with a hyperedge or a vertex. Attribute of the vertex and the hyperedge may be property of the data event and the data relationship associated with vertex and the hyperedge. And an “attributed hypergraph” or “AHG” is a hypergraph such that each of its hyperedges and vertices has an attribute.

In AHG representation according to an embodiment of the present disclosure, each vertex represents a component, or data event of a data domain or a data set. Each pattern or association between the vertices is a composite represented by a hyperedge. The rank (anti-rank) of a hypergraph is the highest (lowest) order of the patterns.

It is noted that in the present disclosure, the association between the vertices represented by a hyperedge does not have to be a pattern, a statistically significant pattern, or statistical pattern. Any kind of association, even any pair of variables and its value found in the data set may be represented as vertices. In other words, all the data events found in a given data set can be or are collected and represented as vertices. As will be described later, this enables embodiments in accordance with the present disclosure to provide a method for further analysis such as manipulation and retrieval of data from the data set.

For a data event e, the star H(e) of hypergraph H with center e represents all the patterns related to the event e. Let A be a subset of all components, the sub-hypergraph of hypergraph H induced by A represents the event associations in A.

The following list gives some hypergraph terminologies and their corresponding meanings in pattern representation in embodiments of the present disclosure:
Each vertex of a hypergraph is a component (or data event or atomic event) of a data domain;
Each hyperedge is a composite, representing a relationship (or a pattern) in the data domain;
The order of a hypergraph is the number of components appearing in the data domain;
The rank of a hypergraph is the highest order of the patterns in the data domain; similarly, the anti-rank is the lowest order of patterns;
For a component (data event or atomic event) xi, the star H(xi) of hypergraph H with center xi represents all the patterns related to the component xi.
Let A be a subset of all components, the sub-hypergraph of hypergraph H induced by A represents the associations among the components in A.

The attributes of both the vertices and the hyperedges may depend on the application(s) and the data set under consideration. For analysis and modeling purposes, necessary information for the later inference process may be included in the attributes.

In an embodiment of the present disclosure, the attribute of each vertex may be the marginal probability of the corresponding component. The attribute of each hyperedge may contain the probability of the composite (compound event), the expected probability of the composite, or the probabilities of sub-composite one order lower. All of these attributes can be used for the retrieval and/or the inference process. Therefore, in accordance with the present disclosure, hyperedges depict or represent the qualitative relations among their elementary vertices, while the attributes associated with the hyperedges and the vertices quantify or represent these relations.

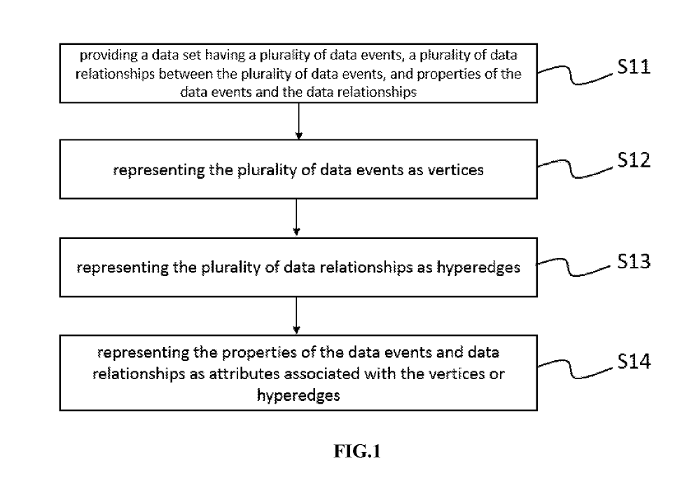

FIG. 1 is a flow chart illustrating a method of representing data set in accordance with an embodiment of the present disclosure.

In step S11, a data set is provided having a plurality of data events, a plurality of data relationships between the plurality of data events, and properties of the data events and the data relationships. Alternatively, the data set is a finite set of m data relationships R={r₁, r₂, . . . , rₙ}, where r₁ (1≦i≦m) is a data relationship containing a finite set of m data events or atomic events, i.e. ri=xj|1≦j≦m.

It is noted that the data set does not have to contain a pattern, a statistically significant pattern, or a statistical pattern. And all the data events are collected from the data set regardless of whether there exist statistical patterns in the plurality of hyperedges. The data event may be any pair of variable-value pair found in the data set.

In step S12, the plurality of data events are represented as vertices. That is, any atomic data event xⱼ (e.g. a variable-value pair) is a vertex in the representation.

In step S13, the plurality of data relationships are represented as hyperedges. Any relationship between two or more data events or between the plurality of data events, r₁, is represented as a hyperedge.

In step S14, every vertex or hyperedge in the attributed hypergraph has its associated data structure, its attribute denoting its properties. The properties of the data events and data relationships are represented as attributes associated with the vertices or hyperedges. The entire data relationship R composes an attributed hypergraph (AHG).

Based upon the representation of the data set using AHG, the data set can be manipulated and updated. Also, using the representation of the data set, data relationships may be retrieved directly.

For example, in accordance with embodiments, the data set may be constructed or initialized by creating an empty AHG with no vertices, hyperedges or attributes. Data fields or data events of the data set may be created by adding vertices, hyperedges and their optional attributes to an existing data set representation. Updating the data set may be achieved by changing attributes, adding new vertices and/or hyperedges, removing vertices and their associated hyperedges/attributes, and deleting hyperedges. Data may be retrieved from the data set by searching out vertices, hyperedges and attributes according to given criteria, or keywords. Data fields or data events may be removed by deleting all relevant vertices, hyperedges, their attributes and the corresponding data itself.

Also, if a new instance is to be classified against a data field X₁ (variable or its value), only the hyperedges containing a data event or its properties of X₁ are interesting. If the system is later asked to find the patterns related to event X₂=True, only the hyperedges containing this event are focused on. Because there are a good number of mature algorithms on graphs, these operations are expected to be computationally efficient. As indicated in a paper by Agrawal, Imielinski and Swami, entitled “Database mining: A performance perspective,” IEEE Trans. on Knowledge and Data Engineering, 5(6):914-925, December 1993, most database mining problems can be classified into three categories: association, classification, and sequence/sequencing. In the AHG framework, associations among events are represented as hyperedges. When class labels are considered as components with special attributes, classification can always be treated as using patterns related to this special field to predict the class membership of a new object. The sequential problem is just a special case of association with a time tag attached as one of the attributes.

Based on the aforementioned representation in accordance with an embodiment, data pattern manipulation functions can be designed and implemented. Basic operators resemble those available in other data management systems.

In an accordance with an embodiment of the present disclosure, operators that may be specific to AHG are as follows:
HighestOrder( ) and LowestOrder( ) to find the highest (lowest) order of detected relationships
GetOrder( ) to obtain the order of a given data patterns
Link( ) to determine if two components are related in anyway related to a specified event, and FindSubEvent( ) which extracts

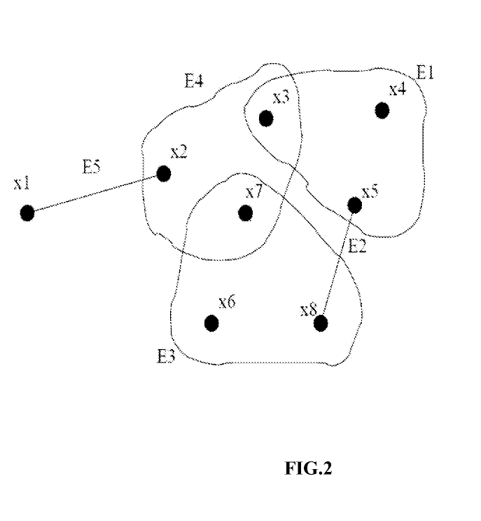

FIG. 2 shows an exemplary hypergraph with 8 vertices and 5 hyperedges in an accordance with an embodiment of the present disclosure.

In the hypergraph shown in FIG. 2, there are 8 vertices, (x₁, x₂, x₃, x₄, x₅, x₆, x₇, x₈) and 5 hyperedges, (E₁, E₂, E₃, E₄, E₅). Vertices are represented as dots and hyperedges are represented as lines connecting or surrounding the associated vertices. As shown FIG. 2, hyperedge, E₁ represents a relationship between x₃, x₄ and x₅, E₂ between x₅ and x₈, E₃ between x₆, x₇ and x₈, E₄ between x₂, x₃, x₇ and E₅ between x₁ and x₂. Each of vertices and hyperedges may be given their attributes even though no attribute is indicated in FIG.

For example, consider a data set containing data regarding animals. The data set describes creatures with variables such as Feather, Milk, Toothed, # of Legs, Tail, Eggs, Aquatic and Type. Then vertices will include Feather=yes, Feather=no, # of Legs=2, # of Legs=4, Type=bird, Type=mammal, etc. A hyperedge, say E1, represents a relationship, say (Feather=yes, Milk=no, Type=bird), another hyperedge, say E2, represents another relationship, say (Aquatic=no, # of Legs=4, Eggs=no), and so on.

Each of vertices and hyperedges may have attributes associated with them, making them attributed hyperedges. In accordance with an embodiment, one possible attribute can be the marginal probability of occurrence in the data set. A probability of the data event corresponding to a vertex may be an attribute of the vertex and a probability of the compound event corresponding to a hyperedge may be an attribute of the hyperedge in the data set given.

For the above example, the probability of the data event may be a marginal probability, that is, a probability of the data event occurrence in the data set. Also, the probability of the compound events may be a probability of the compound events' occurrences in the data set. The probability of a compound event may be the probability of actual occurrence or a calculated probability based upon the marginal probabilities of the data events composing the compound event.

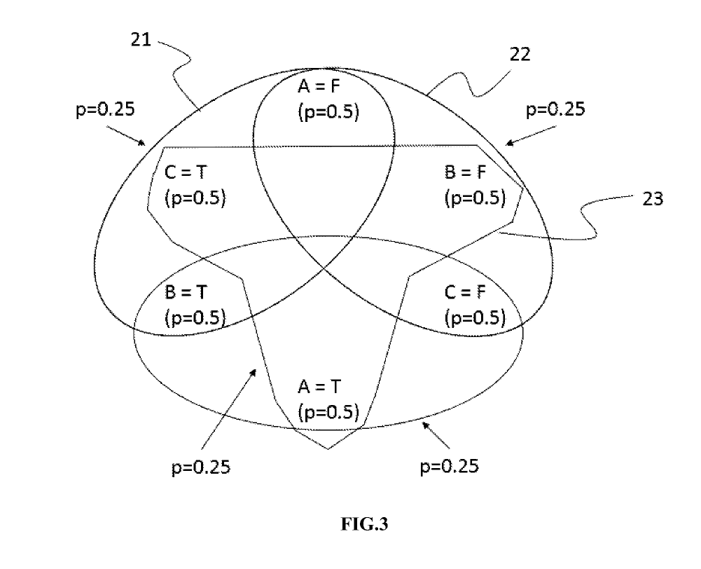

The data representation in accordance with an embodiment of the present disclosure may be applied to data patterns. FIG. 3 shows the data set representation that has the patterns in the XOR relationship. The data set contains three parameters and their logical values. In total, there are six vertices and four hyperedges. Each hyperedge represents a pattern. The attributes of the vertices are shown in brackets and the hyperedges are indicated by arrows.

In FIG. 3 the attributes are the probabilities of the compound events. Hyperedges qualitatively represent the associations among data events while the attributes describe the numerical properties of these association patterns. The significance level of each hyperedge may be calculated by its observed and expected occurrences. In FIG. 3, only third order patterns exist in the XOR relationship.

In FIG. 3, hyperedge 21 comprises vertices (A=F, C=T, B=T). The expected occurrence of hyperedge 21 is calculated as multiplication of probabilities of each vertex, that is, ½*½*½=⅛. However, probabilities from the actual or observed occurrence is 0.25 which is higher than the expected occurrence, ⅛(=0.125). So, hyperedge 21 can be said to represent a pattern. In the same manner, hyperedges 22 and 23 can be said to represent or be patterns.

In summary, the attributed hypergraph representation according to the present disclosure can directly reflect the nature of the data set. The patterns encoded in an AHG are of different complexities according to how much detailed information they contain. Along with the attributes assigned to each vertex and hyperedges, AHG provides a framework for future reasoning and inference. The AHG representation permits the encoding of both conceptual and relational descriptions at many levels of abstraction to exist simultaneously within the framework. This property is extremely desirable when forming conceptual clustering algorithms, such as further described in a paper by P. Langley, “Machine learning and concept formation,” Machine Learning, 2(4):99-102, 1987. At the event level, an AHG captures the basic associations among the events within a data set and avoids many shortcomings of other graphical representations. The AHG representation by nature has data analysis and inferencing embedded and is superior in data analysis for large systems compared to other data models.

Other architectures, implementations, and organizations will be understood by those skilled in the art to be included within the scope of the embodiments of the present disclosure. Computer software products can be implemented in a variety of programming languages, including without limitation hypertext markup language (“HTML”), Java, C, C++, XML, JavaScript, and others as understood by those skilled in the art. Multi-processor computers, cloud computing, server farms, multiple computer systems, multiple databases and storage devices (including hierarchies of storage and access), and other implementations will be recognized by those having skill in the art as encompassed within the scope of embodiments of the present disclosure. For example, a single computer, a plurality of computers, a server, or server cluster, or server farm may be employed, and this disclosure does not limit any configuration of computers and servers for each. Moreover, each may be deployed at a server farm, data center, or server cluster managed by a server host, and the number of servers and their architecture and configuration may be increased based on usage, demand, and/or capacity requirements for the system. Moreover, embodiments include clusters of computers, servers, storage devices, display devices, and components interacting together, as understood by those skilled in the art.

A person having ordinary skill in the art will recognize that various types of memory and media readable by a computer such as described herein, e.g., a user computer, file management computer server, or other computers and machines within the scope of embodiments of the present disclosure. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include or contain operating instructions stored therein/thereon, as well as instructions or instruction sets related to the system and particular method steps described above, and can operate on a computer by way of processing unit execution. It will be understood by those skilled in the art that such media can be at other locations instead of or in addition to a file management computer server to store program products, e.g., including software, thereon.

While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, components, processes, or alternatives thereof, may be desirably combined into other different systems, components, processes, and/or applications. In addition, various modifications, alterations, and/or improvements may be made to various embodiments that are disclosed by a person of ordinary skill in the art within the scope of the present disclosure.

1. A method of representing large body of data using data relationships, comprising steps of:
providing a data set having a plurality of data events, a plurality of data relationships between the plurality of data events, and properties of the data events and the data relationships, the data set being generated from a data source such that all the data events in the data source are collected regardless of whether there exist statistical patterns in the plurality of hyperedge;
representing the plurality of data events as vertices;
representing the plurality of data relationships as hyperedges; and
representing the properties of the data events and data relationships as attributes associated with the vertices or hyperedges, respectively.

2. The method of claim 1, wherein the attributes of the data events or the data relationships are probabilities of occurrences of the data event of the data relationship in the data set.

3. The method of claim 1, wherein the hyperedges represent the qualitative relations among their vertices, and the attributes of the hyperedges and the vertices quantify the relations.

4. The method of claim 1, further comprising:
updating the data set as at least one of the data events, the data relationships and the properties of the data events or the data relationships are changed.

5. The method of claim 4, wherein the step of updating the data set further comprises at least one steps of:
changing the attributes;
adding vertices for new data events; and
deleting vertices, their associated hyperedges or their associated attributes.

6. The method of claim 1, wherein the data events are comments collected from social networking service and the data relationships are words commonly found in the data events.

7. The method of claim 1, wherein the data events are records of credit card transactions and the data relationships comprise at least one of location of the transaction and type of the transaction.

8. A computer readable medium containing program code for representing large body of data using data relationships which executes the steps of:
providing a data set having a plurality of data events, a plurality of data relationships between the plurality of data events, and properties of the data events and the data relationships, the data set being generated from a data source such that all the data events in the data source are collected regardless of whether there exist statistical patterns in the plurality of hyperedge;
representing the plurality of data events as vertices;
representing the plurality of data relationships as hyperedges; and
representing the properties of the data events and data relationships as attributes associated with the vertices or hyperedges, respectively.

9. The computer readable medium of claim 8, wherein the properties of the data events or the data relationships are probabilities of occurrences of the data events or the data relationships in the data set.

10. The computer readable medium of claim 8, wherein the hyperedges represent the qualitative relationships among their vertices, and the attributes of the hyperedges and the vertices quantify the relationships.

11. The computer readable medium of claim 8, further comprising:
updating the data set as at least one of the data events, the data relationships and the properties of the data event or the data relationship are changed.

12. The computer readable medium of claim 11, wherein the step of updating the data set further comprises at least one steps of:
changing the attributes;
adding vertices for new data events; and
deleting vertices, their associated hyperedges or their associated attributes.

13. A method of manipulating large body of data using attributed hypergraph, comprising steps of:
providing a data set containing a plurality of data events and data relationships between the two or more data events in which the data events are represented as vertices, the data relationships are represented as hyperedges, and properties of the data events and the data relationships are represented as attributes of the vertices and the hyperedges respectively, the data set being generated from a data source such that all the data events in the data source are collected regardless of whether there exists any statistical patterns in the data set; and
updating the data set as at least one of the data events, the data relationships and the properties of the data events or the data relationships are changed.

14. The method of claim 13, wherein the properties of the data events or the data relationships are probability of occurrences of the data event of the data relationship in the data set.

15. The method of claim 13, wherein the step of updating the data set further comprises at least one steps of:
changing the attributes;
adding vertices for new data events; and
deleting vertices, their associated hyperedges or their associated attributes.

16. A method of retrieving large body of data using attributed hypergraph, comprising steps of:
providing a data set containing a plurality of data events and data relationships between the plurality of data events in which the data events are represented as vertices, the data relationships are represented as hyperedges, and properties of the data events and the data relationships are represented as attributes of the vertices and the hyperedges respectively, the data set being generated from a data source such that all the data events in the data source are collected regardless of whether there exists any statistical patterns in the data set;
receiving criteria;
retrieving hyperedges and attributes associated with the criteria; and
outputting search results.

17. The method of claim 16, wherein the properties of the data events or the data relationships are probability of occurrences of the data events of the data relationships in the data set.

18. The method of claim 16, wherein the data events are comments collected from social networking service and the data relationships are words commonly found in the data events.

19. The method of claim 16, wherein the data events are records of credit card transactions and the data relationships comprise at least one of location of the transaction, type of the transaction.
